(19) United States
(12) Patent Application Publication
(10) Pub. No.: US 2008/0064449 A1
(43) Pub. Date: Mar. 13, 2008

(54) Wireless communication system and charging base thereof

(75) Inventors: Yung-Lang Huang, Taipei (TW); Tian-Sen Wu, Taipei (TW); Feng-Shin Lin, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/699,016

(22) Filed: Jan. 29, 2007

(30) Foreign Application Priority Data
Sep. 12, 2006 (TW) 095133729

(51) Int. Cl. H04B 1/38; H04M 1/00

(52) U.S. Cl. 455/573

(57) ABSTRACT

A wireless communication system includes a charging base, a phone, a computer host and a wireless communication module. The charging base has a charging socket, a data transmission port and a wireless communication socket. The wireless communication socket is electrically connected with the data transmission port. The phone inserts in the charging socket of the charging base to be charged. The computer host is electrically connected with the data transmission port of the charging base through a transmission cable. The wireless communication module inserts in the wireless communication socket of the charging base and communicates with the phone according to a wireless communication protocol. When the phone transmits information, the wireless communication module receives the information and transmits it to the computer host through the data transmission port and the transmission cable.

### BACKGROUND OF THE INVENTION

1. Field of the Invention

The invention relates to a communication system and, more particularly, to a wireless communication system and the charging base thereof.

2. Description of the Related Art

With the development of communication technology and the improvement of people's life quality, the demand regarding the quality and functions of communication system is increasing.

Referring to FIG 1, a wireless communication system 1 includes a wireless communication module 11, a computer host 12 and a Skype phone 13. The wireless communication module can be a wireless network card and is electrically connected to a motherboard of the computer host 12 (Not shown in the figure). When users are talking to the others by the Skype phone 13, the voice data Dv sent by the Skype phone 13 are transmitted to the wireless communication module 11. After receiving the voice data Dv, the wireless communication module 11 transmits the data to the computer host 12, and then the computer host 12 transmits the voice data Dv to other users via the internet.

However, the wireless communication module 11 is provided on the back of the computer host 12, so it is often shielded by the computer host 12 and only can receive the voice data Dv under a particular angle. Therefore, the quality of communication may be not good, and this brings inconvenience to the users.

Therefore, it is an important subject to provide a wireless communication system which can arrange the wireless communication module flexibly and avoid being shielded by the computer host.

### SUMMARY OF THE INVENTION

In view of the subject mentioned above, an objective of the invention is to provide a charging base with the function of wireless communication and a wireless communication system in which the charging base is used.

To achieve the above objective, the wireless communication system of the invention includes a charging base, a phone, a computer host, and a wireless communication module. The charging base includes a charging socket, a data transmission port, and a wireless communication socket electrically connected to the data transmission port. The phone is inserted in the charging socket of the charging base for power charging. The computer host is electrically connected to the data transmission port of the charging base through a transmission cable. The wireless communication module is inserted in the wireless communication socket of the charging base and communicates with the phone according to a wireless communication protocol. When the phone transmits data, the wireless communication module receives the data and transmits them to the computer host through the data transmission port and the transmission cable.

Additionally, to achieve the above objective, a charging base with the function of wireless communication is used together with a computer host, a wireless communication module, a phone, and a transmission cable. The charging base includes a body, a charging socket, a data transmission port, and a wireless communication socket. The charging socket is provided in the body, wherein the phone can be inserted in the charging socket for power charging. The data transmission port is provided in the body, and the transmission cable electrically connects the data transmission port with the computer host. The wireless communication socket is provided in the body and electrically connected with the data transmission port. When the wireless communication module is inserted in the wireless communication socket and the phone transmits the data, the wireless communication module receives the data and transmits them to the computer host through the data transmission port and the transmission cable.

From those mentioned above, the charging base of the invention includes a wireless communication socket in which the wireless communication module can be inserted to receive information sent by the phone. Therefore, the invention can avoid the problem that the wireless communication module only can receive the voice data Dv sent under a particular angle as the wireless communication module is shielded by the computer host, and can improve the quality of the communication. Additionally, if users need to place wireless communication module flexibly, they just need to move the charging base to change the position of the wireless communication module.

Therefore, the invention can avoid the problem that the wireless communication module can only be arranged on the back of the computer host and cannot be moved arbitrarily, and can bring convenience to the users. Furthermore, the charging base of the invention includes a charging socket, that is, the charging base provides not only the function of wireless communication but also the function of charging, thus add more functions to the product.

### BRIEF DESCRIPTION OF THE DRAWINGS

FIG. 1 is a three-dimensional schematic diagram showing a conventional wireless communication system;

FIG. 2 is a three-dimensional schematic diagram showing the wireless communication system according to the first embodiment of the invention; and

FIG. 3 and FIG. 4 are a group of system diagrams showing the wireless communication system according to the first embodiment.

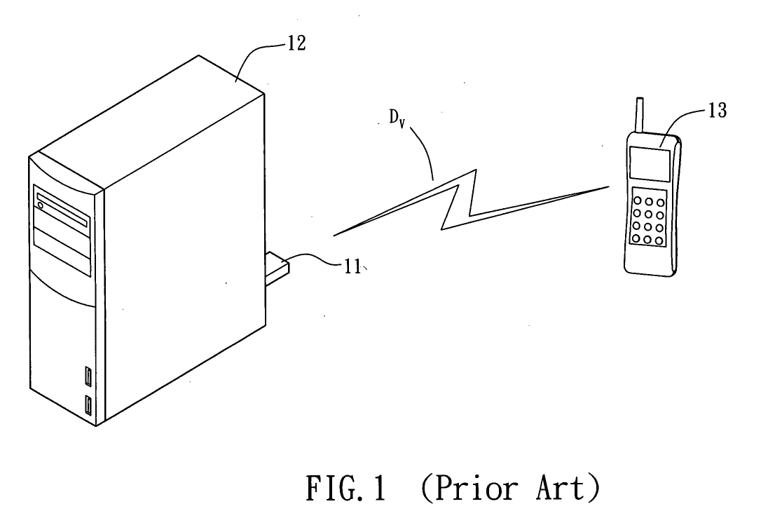

### DETAILED DESCRIPTION OF THE EMBODIMENT

The wireless communication system and the charger according to the embodiment of the invention will be described herein below with relevant drawings, wherein the same element will be referred with the same reference numbers.

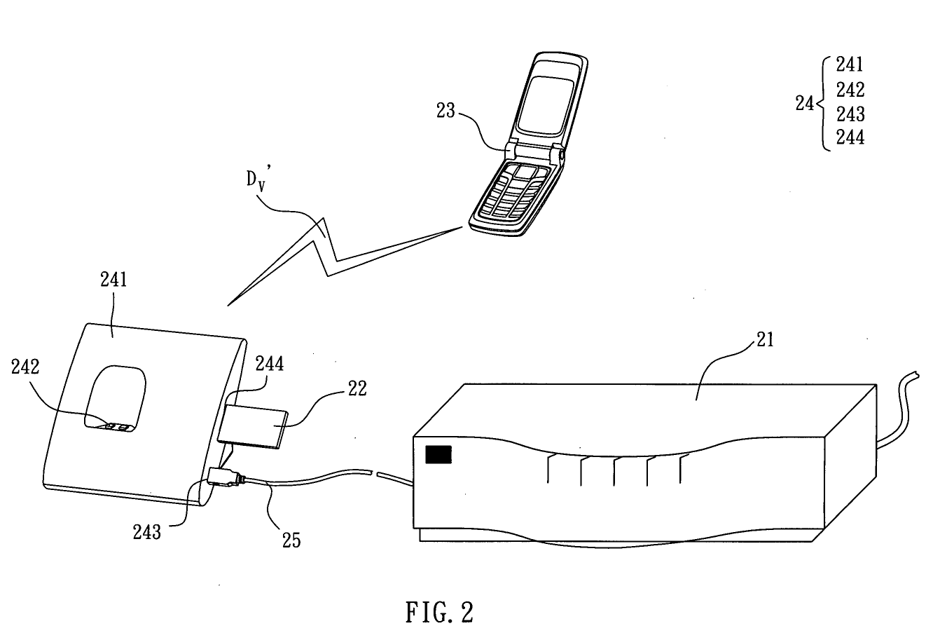

Referring to FIG. 2, the wireless communication system according to the preferred embodiment of the invention includes a computer host 21, a wireless communication module 22, a phone 23, a charging base 24, and a transmission cable 25. The charging base 24 includes a body 241, a charging socket 242, a data transmission port 243, and a wireless communication socket 244.

In the embodiment, the charging socket 242, the data transmission port 243 and the wireless communication socket 244 are provided in the body 241, and they are integrated on one circuit board (Not shown in the figure).

Additionally, in the embodiment of the invention, the body 241 may include a casing with multiple openings for exposing the charging socket 242, the data transmission port 243, and the wireless communication socket 244.

Furthermore, in the embodiment, the wireless communication socket 244 is electrically connected to the data transmission port 243, and the transmission cable 25 is electrically connected to the computer host 21 and the data transmission port 243. Wherein, the transmission cable 25 can have different design in view of actual situations. For example, it may be a USB transmission cable or an IEEE1394 transmission cable.

When inserted in the wireless communication socket 244, the wireless communication module 22 can communicate with the phone 23 according to a wireless communication protocol. When the phone transmits data Dv′, the wireless communication module 22 receives the data Dv′ and transmits the data to the computer host 21 through the transmission cable 25. Then, the computer host 21 transmits the data Dv′ to other users (Not shown in the figure). It is certain that the computer 21 also can receive data from other users and transmit the data to the phone 23 through the transmission cable 25 and the wireless communication module 22 so that the user can communicate with other users.

Specifically speaking, when the user communicates with other users by the phone 23, the phone 23 transmits the data Dv′ to the computer host 21 through the wireless communication module 22, the data transmission port 243, and the transmission cable 25. Then, the computer host 21 transmits the data to users of other computer hosts by the internet, or to other public service telephone network (PSTN) users by the Internet, gateways, or PSTN. Similarly, other users can communicate with the user through the inverted path. The details are omitted here for concise purpose.

In the embodiment, the wireless communication module 22 can have different designs according to actual needs. For example, it may be a WiFi network card, a bluetooth network card, a WiMAX network card, and so on. The phone 23 can be an internet phone, such as a Skype phone. Additionally, the data transmitted by the phone 23 may be voice data, brief message, or files uploaded or downloaded by the phone 23.

From the above, the charging base 24 includes a wireless communication socket 244, and the wireless communication module 22 can be inserted in the wireless communication socket 244 to receive the data sent by the phone 23 or to send data to the phone 23. Therefore, the invention can avoid the problem that the wireless communication module 11 only can receive the voice data Dv sent under a particular angle to avoid being shielded by the computer host 12, and can improve the quality of the communication.

In addition, if the user needs to arrange the wireless communication module 22 flexibly, he or she just needs to move the charging base 24 to change the position of the wireless communication module 22. Therefore, the invention can avoid the problem that the wireless communication module can only be arranged on the back of the computer host 12 and cannot be moved arbitrarily, and can bring convenience to the user.

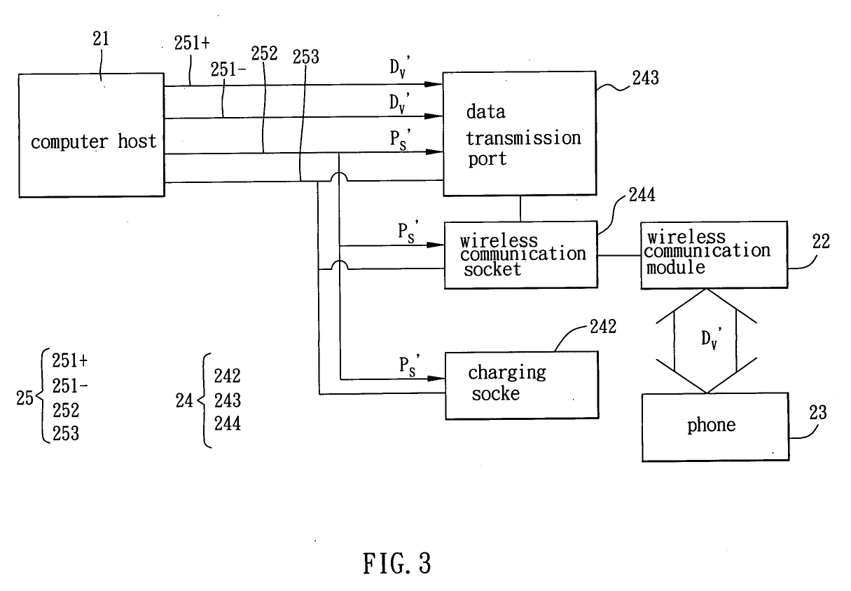

Furthermore, please refer to FIG. 3, the computer host 21 of the embodiment not only can receive/send the data Dv but also can output power Ps′ to the wireless communication socket 244 through the transmission cable 25 to supply power to drive the wireless communication module 22. Therefore, no extra power supply is needed. For example, if the transmission cable 25 is a USB transmission cable, it has a set of serial wires 251+, 251−, a power supply wire 252 and an ground wire 253. The serial wires 251+, 251− are used to transmit the data Dv′, and the power supply wire 252 is used to transmit power Ps′ of 5V.

Additionally, the charging socket 242 may be connected to the data transmission port 243, and the computer host 21 can output the power Ps′ to the charging socket 242 for charging the phone 23 through the power supply wire 252 of the transmission cable 25. If the phone 23 is inserted in the charging socket 242, it can be charged by the power Ps′ , and no extra power supply is needed.

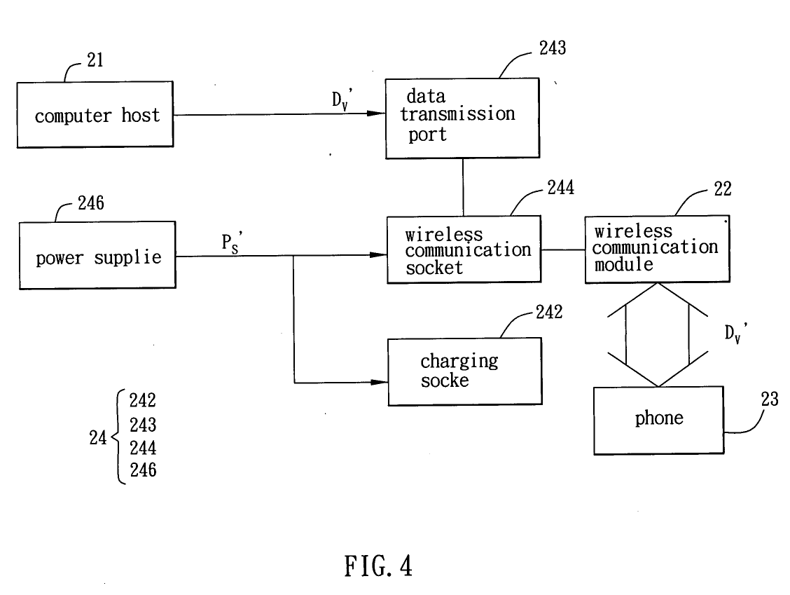

In addition, please refer to FIG. 4, the charging base 24 further includes a power supplier 246 electrically connected to the wireless communication socket 244 and the charging socket 242, to supply power to drive the wireless communication module 22 and charge the phone 23, respectively.

Certainly, persons with ordinary skill in the art may use different variation aspects in view of actual needs. For example, the power to drive the wireless communication module 22 can be supplied by the power Ps′ sent by the computer host 21 through the transmission cable 22, and the power to charge the phone 23 can be supplied by the power supplier 246 (Not shown in the figure). It is also possible that the power to drive the wireless communication module 22 can be supplied by the power supplier 246 and the power to charge the phone 23 can be supplied by the power Ps′ sent by the computer host 21 through the transmission cable 22 (Not shown in the figure).

As mentioned above, since the charging base 24 further includes the charging socket 242, the charging base 24 can provide not only the function of wireless communication but also the function of charging. The users can insert the phone 23 in the charging socket 242 to charge it with the phone being standby simultaneously. The charging socket 242 of the charging base may act as an holding groove to hold the phone 23. This not only adds functions to the product but also bring convenience to the users.

The charging base with the function of wireless communication according to the second embodiment of the invention is used together with a computer host, a wireless communication module, a phone and a transmission cable, wherein the charging base includes a body, a charging socket, a data transmission port and a wireless communication socket.

The charging socket is provided in the body, and the phone can be inserted in the charging socket for charging. The data transmission port is provided in the body, wherein the transmission cable is electrically connected with the data transmission port and the computer host. The wireless communication socket is provided in the body and electrically connected with the data transmission port. When the wireless communication socket is inserted in the wireless communication socket and the phone transmits data, the wireless communication module receives the data and transmits them to the computer host through the data transmission port and the transmission cable

The charging base of the embodiment has been described in detail in the description of the wireless communication system of the first embodiment. Therefore relevant description is omitted here for concise purpose.

To sum up, the charging base of the invention includes a wireless communication socket, and the wireless communication module can be inserted in the wireless communication socket of the charging base to receive the data sent by the phone. Therefore, the invention can avoid he problem that the wireless communication module only can receive the voice data Dv sent under a particular angle as the wireless communication module is shielded by the computer host, and further to improve the quality of the communication. In addition, if users need to arrange wireless communication module flexibly, they just need to move the charging base to change the arrangement of the wireless communication module. Therefore, the invention can avoid the problem that the wireless communication module can only be arranged on the back of the computer host and cannot be moved arbitrarily, and is more convenient to the users. Furthermore, the charging base of the invention further includes a charging socket, that is, the charging base provides not only the function of wireless communication but also the function of charging. This adds more functions to the product.

The above mentioned are only embodiments but not limitation. Any modifications and changes without departing from the scope and spirit of the invention are included in the scope of the appended claims

What is claimed is:

1. A wireless communication system, comprising:
a charging base including a charging socket, a data transmission port, and a wireless communication socket, the wireless communication socket electrically connected with the data transmission port;
a phone capable of being inserted in the charging socket of the charging base for charging;
a computer host electrically connected with the data transmission port of the charging base through a transmission cable; and
a wireless communication module being inserted in the wireless communication socket of the charging base and communicating with the phone based on a wireless communication protocol, wherein when the phone transmits data, the wireless communication module receives the data and transmits them to the computer host through the data transmission port and the transmission cable.

2. The wireless communication system according to claim 1, wherein the computer host can output power to the wireless communication socket through the transmission cable to drive the wireless communication module.

3. The wireless communication system according to claim 1, wherein the charging socket is electrically connected with the data transmission port and the computer host outputs power transmitted to the charging socket through the transmission cable to charge the phone.

4. The wireless communication system according to claim 1, wherein the transmission cable is a USB transmission cable or an IEEE1394 transmission cable.

5. The wireless communication system according to claim 1, wherein the charging base further includes a power supply electrically connected with the data transmission port and the charging socket to drive the wireless communication module and charge the phone separately.

6. The wireless communication system according to claim 1, wherein the wireless communication module is a WiFi network card, a Bluetooth network card, or a WiMAX network card.

7. The wireless communication system according to claim 1, wherein the phone is an internet phone.

8. The wireless communication system according to claim 7, wherein the internet phone is a Skype phone.

9. A charging base with wireless communication functionality, which operates together with a computer host, a wireless communication module, a phone, and a transmission cable, the charging base comprising:
a body;
a charging socket provided in the body, wherein the phone can be inserted in the charging socket for charging;
a data transmission port provided in the body, wherein the transmission cable electrically connects the data transmission port with the computer host; and
a wireless communication socket provided in the body and electrically connected with the data transmission port, wherein when the phone transmits data, the wireless communication module receives the data and transmits them to the computer host through the data transmission port and the transmission cable.

10. The charging base according claim 9, wherein the computer host can output power to the wireless communication socket through the transmission cable to drive the wireless communication module.

11. The charging base according to claim 9, wherein the data transmission port is electrically connected with the charging socket and the computer host outputs power transmitted to the charging socket through the transmission cable to charge the phone.

12. The charging base according to claim 9, wherein the transmission cable is a USB transmission cable or an IEEE1394 transmission cable.

13. The charging base according to claim 9, further comprising a power supply electrically connected with the data transmission port and the charging socket to drive the wireless communication module and charge up the phone.

14. The charging base according to claim 9, wherein the wireless communication module is a WiFi network card, a Bluetooth network card or a WiMAX network card.

15. The charging base according to claim 9, wherein the phone is an internet phone.

16. The charging base according to claim 15, wherein the internet phone is a Skype phone.
